(19) United States
(12) Patent Application Publication
(10) Pub. No.: US 2014/0298245 A1
(43) Pub. Date: Oct. 2, 2014

(54) Display Instance Management

(71) Applicant: MICROSOFT CORPORATION, Redmond, WA (US)

(72) Inventors: Henry P. Tappen, Kirkland, WA (US); Christopher E. Swan, Seattle, WA (US); Yaou Wei, Bellevue, WA (US); Jenica Carryl O. Siy, Issaquah, WA (US)

(73) Assignee: Microsoft Corporation, Redmond, WA (US)

(21) Appl. No.: 13/852,903

(22) Filed: Mar. 28, 2013

(51) Int. Cl. G06F 3/0481

(52) U.S. Cl. CPC G06F 3/0481
USPC 715/781

(57) ABSTRACT

Display instance management techniques are described. In one or more implementations, an application manager module of a computing device is executed that is configured to manage which display instances of the plurality of applications are made available via a user interface at a particular time. One or more application programming interfaces (APIs) are exposed by the application manager module that are configured to support switching by the application manager module between a plurality of the display instances for a respective single one of the plurality of applications in the user interface.

### BACKGROUND

Computing devices continue to evolve as users desire to interact with the devices in an increasing variety of circumstances. One such example is mobile communication devices such as mobile phones that evolved from basic telephone functionality to the ability to run applications. Another such example is a slate computer, which may also be referred to as a tablet. Both of these examples are configured to be held by a user during interaction and thus techniques were developed to address this configuration, one such example of which is an immersive environment.

Immersive environments are typically employed by mobile communication devices to aide interaction with the applications due to the form factors employed by the devices. Typically, however, applications executed in the immersive environment were limited to a single destination within the environment at any one time, which could limit the functionality made available to the users.

### SUMMARY

Display instance management techniques are described. In one or more implementations, an application manager module of a computing device is executed that is configured to manage which display instances of the plurality of applications are made available via a user interface at a particular time. One or more application programming interfaces (APIs) are exposed by the application manager module that are configured to support switching by the application manager module between a plurality of the display instances for a respective single one of the plurality of applications in the user interface.

In one or more implementations, a system comprises one or more modules implemented at least partially in hardware, the one or more modules configured to curate content specified by respective ones of a plurality of applications for display in a plurality of display instances in a user interface such that respective applications specify the content but are not aware as to how that content is displayed, the content of at least two display instances being specified by a single one of the applications.

In one or more implementations, one or more computer-readable storage media comprise instructions stored thereon that, responsive to execution by a computing device, causes the computing device to execute an application manager module. The application manager module is configured to perform operations comprising exposing one or more application programming interfaces (APIs) that are configured to support switching between a plurality of display instances for a respective ones of a plurality of applications in a user interface, managing lifetimes of the plurality of display instances of the plurality of applications, and curating content specified by respective ones of a plurality of applications for display in the plurality of display instances.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to implement display instance management techniques described herein.

FIG. 2 illustrates a system in an example implementation of an application manager module of FIG. 1 as supporting display instance management techniques.

FIG. 3 depicts an example implementation of a system showing management of applications and display instances of applications by the application manager 114.

FIG. 4 depicts a system in an example implementation in which navigation between display instances of a single application using an edge gesture is shown.

FIG. 5 depicts a system in an example implementation in which selection and configuration of a display instance in a manner that mimics selection and docking of an application is shown.

FIG. 6 is an illustration of a system in an example implementation showing areas of a display environment defined by thresholds to perform different actions after selection of display instances of an application.

FIG. 7 depicts a procedure in an example implementation in which an application manager module is executed to manage a plurality of display instances for a single application.

FIG. 8 illustrates an example system that includes the computing device as described with reference to FIG. 1.

FIG. 9 illustrates various components of an example device that can be implemented as any type of computing device as described with reference to FIGS. 1-8 to implement embodiments of the techniques described herein.

### DETAILED DESCRIPTION

Overview

Immersive environments, such as those commonly found on mobile phones and tablets, typically allow users to only view one destination or document inside an application at any given time. Users, though, may wish to compare two different documents in the same application, reference one location while working in another one, and so on. Although some applications were developed that allowed users to view two parts of the application at the same time, it does so in a manner specific to the application. Therefore, this typically involved specific coding on the part of an application developer and further did not participate in a computing device's overall multitasking experience.

Display instance management techniques are described. In one or more implementations, an application manager module is configured to manage an immersive environment in which more than one display instance of an application may be accessed. For example, this access may be configured to be performed in a manner that mimics functionality utilized to access other applications, such as gestures or other inputs to switch between applications, access a list of which applications are currently available, and so on. In this way, a multitasking paradigm of the application manager module that is supported as part of an operating system of a computing device may be leveraged to support different instances of an application without special coding for each of the applications. A variety of other techniques are also contemplated, such as to include lifetime management of the display instances, curated content by the application manager module for the applications, and so on. Further discussion of these and other techniques may be found in relation to the following figure.

In the following discussion, an example environment is first described that may employ the display instance management techniques described herein. Example procedures are then described which may be performed in the example environment as well as other environments. Consequently, performance of the example procedures is not limited to the example environment and the example environment is not limited to performance of the example procedures.

Example Environment

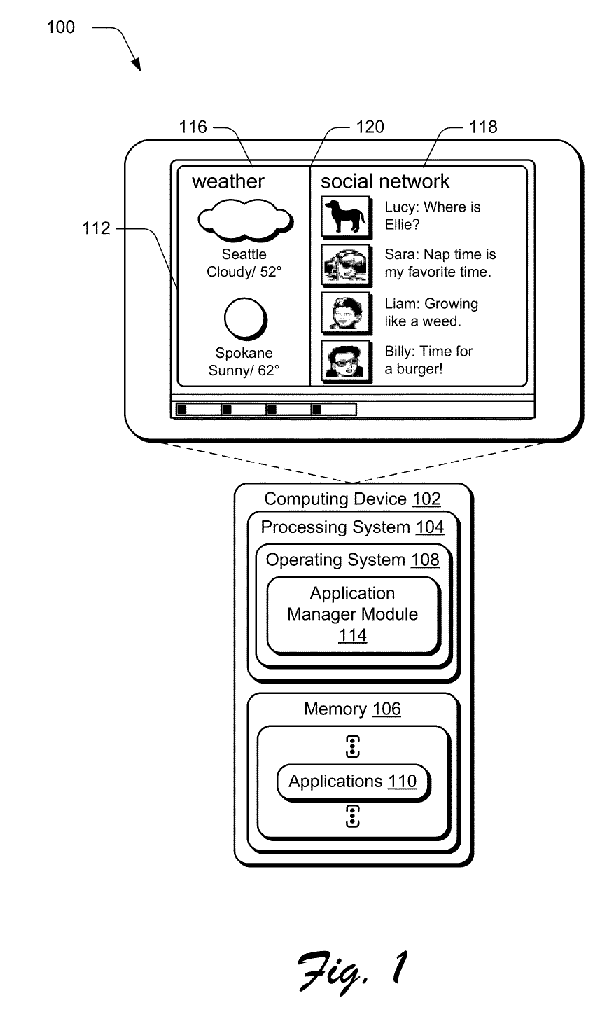

FIG. 1 is an illustration of an environment 100 in an example implementation that is operable to employ display instance management techniques described herein. The illustrated environment 100 includes a computing device 102 having a processing system 104 and a computer-readable storage medium that is illustrated as a memory 106 although other confirmations are also contemplated as further described below.

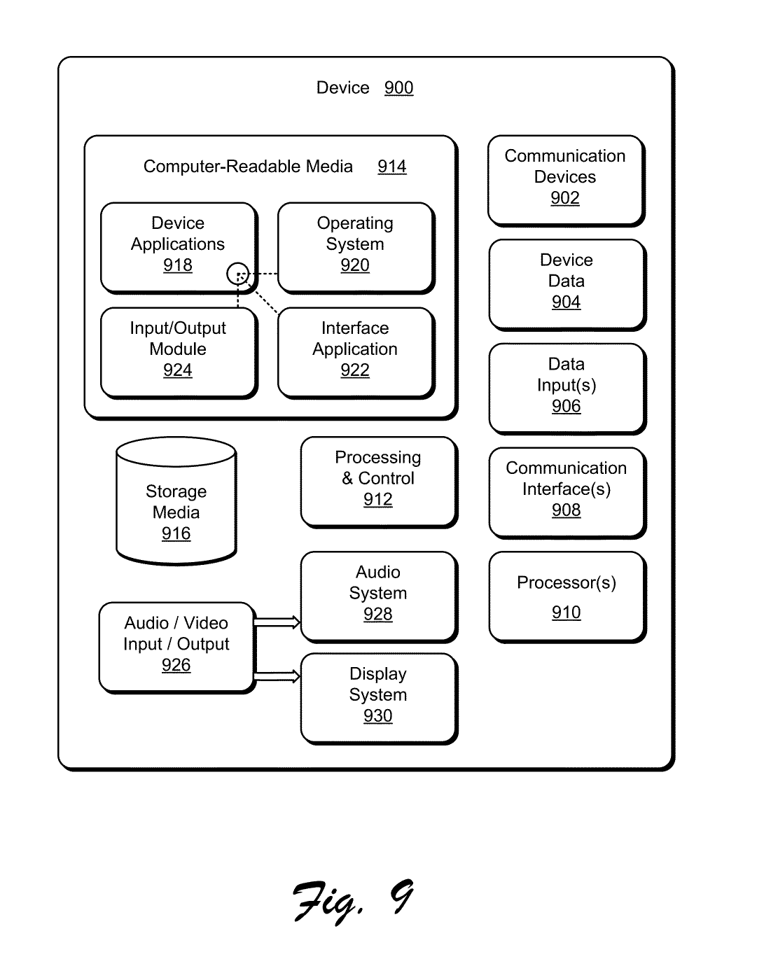

The computing device 102 may be configured in a variety of ways. For example, a computing device may be configured as a computer that is capable of communicating over a network, such as a desktop computer, an entertainment appliance, a set-top box communicatively coupled to a display device, a game console, and so forth. The computing device 102 may also be configured as a mobile communications device, such as a tablet as illustrated, a mobile phone, portable game device, portable music device, electronic notebook, and so on. Thus, the computing device 102 may range from full resource devices with substantial memory and processor resources (e.g., personal computers, game consoles) to a low-resource device with limited memory and/or processing resources (e.g., traditional set-top boxes, hand-held game consoles) as further described in relation to FIG. 9. Additionally, although a single computing device 102 is shown, the computing device 102 may be representative of a plurality of different devices, such as multiple servers utilized by a business to perform operations such as by a web service, a remote control and set-top box combination, an image capture device and a game console configured to capture gestures, and so on.

The computing device 102 is further illustrated as including an operating system 108. The operating system 108 is configured to abstract underlying functionality of the computing device 102 to applications 110 that are executable on the computing device 102. For example, the operating system 108 may abstract the processing system 104, memory 106, network, and/or display device 112 functionality of the computing device 102 such that the applications 110 may be written without knowing “how” this underlying functionality is implemented. The application 110, for instance, may provide data to the operating system 108 to be rendered and displayed by the display device 112 without understanding how this rendering will be performed. The operating system 108 may also represent a variety of other functionality, such as to manage a file system and user interface that is navigable by a user of the computing device 102.

The operating system 108 is also illustrated as including an application manager module 114 which is representative of functionality of the computing device 102 to provide an environment via which a user may interact with the applications 110 and other data of the computing device 102, both local to the device as well as remotely via a network. A variety of different environments may be supported by the application manager module 114, which may be configured to accept inputs to interact with the operating system 108 and applications 110 of the computing device 102 to access functionality of the computing device 102, such as the abstracted functionality described above.

One such environment is referred to as an immersive environment which may be configured to support interaction with the applications 110 with little to no window frame. Additionally, the immersive environment may support interaction with the applications 110 without requiring the user to manage a corresponding window frame's layout, primacy of the window with respect to other windows (e.g., whether a window is active, in front of behind other windows, an order of the windows, and so on). Other examples are also contemplated, such as to manage a lifetime of an application, manage which applications are actively executed based on whether content of the application is currently being output for viewing by the computing device 102, and so on. Although illustrated as part of the operating system 108, the application manager module 114 may be implemented in a variety of other ways, such as a stand-alone module, remotely via a network, and so forth.

In one or more implementations, the immersive environment of the operating system 108 is configured such that it is not closeable or capable of being uninstalled apart from the operating system 108. Additionally, the immersive environment may be configured to consume a significant portion of an available display area of the display device 112. A user may interact with the immersive environment in a variety of ways, such as via a cursor control device, using one or more gestures involving a touch input, using speech recognition, capture using one or more depth-sensing cameras, and so on. Thus, the application manager module 114 may manage the immersive environment in which content of applications 110 may be presented and the presentation may be performed without requiring a user or application 110 to manage size, location, primacy, and so on of windows used to display the content of the applications 110. The application 110, for instance, may specify content to be displayed but may not be aware as to how that display is to be performed.

For example, as shown on a user interface displayed by the display device 112, a user interface is shown that is configured to display data 116, 118 from applications in a “docked” configuration. In this example, both of the applications that correspond to the data are enabled to actively execute by the computing device 102 while execution is suspended for other of the applications 110 that do not currently display data. A separator 120 is disposed between the displays of the data 116, 118 that may be moveable to change an amount of display area consumed by applications on the display device 112, respectively.

The immersive environment may support a wide variety of functionality to provide an immersive experience for a user to access the applications 110. In the following discussion, this functionality is discussed in relation to leveraging these techniques to manage display instances of an application. It should be readily apparent, however, that these techniques may be employed for managing interaction in other environments and/or with the applications 110 themselves without departing from the spirit and scope thereof.

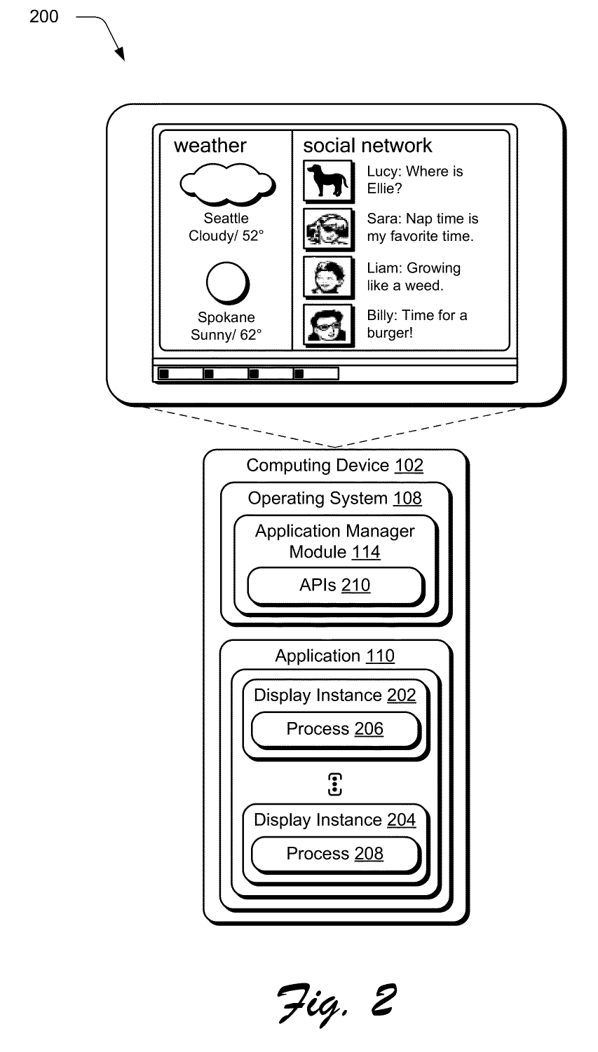

For example, the application manager module 114 may also be configured to support a desktop environment. The desktop environment is representative of another configuration of a user interface output by the operating system 108 when in this example is to interact with the applications 110 and other data. For example, the desktop environment may be configured to present applications and corresponding data through windows having frames. These frames may provide controls through which a user may interact with an application as well as controls enabling a user to move and size the window. The desktop environment may also support techniques to navigate through a hierarchical file structure through the use of folders and represent the data and applications through use of icons. Thus, it should be readily apparent that the techniques described to manage display instances of applications herein may be supported in a wide range of environments, such as an immersive environment, a desktop environment, or other environment as further described in relation to FIG. 2.

Further, these techniques are not limited to inputs provided by a user. For example, the application manager module 114 may incorporate a process lifetime manager (PLM) that is configured to automatically manage whether applications 110 are actively executed, suspended (e.g., frozen—still open but not consuming processing system 104 resources), or terminated (e.g., closed). As applications 110 transition between these parts of the “application lifecycle,” the application may receive two events—visibility and suspension—that indicate whether the application 110 is “visible” on-screen and/or whether the application 110 is about to become “suspended.” These events help to make the application 110 aware as to what to expect next, which may be used to indicate to the application 110 to save certain types of data. Accordingly, the application manager module 114 may be configured to ensure that the applications 110 proceed through the typical “application lifecycle” and therefore receives these same events when closed, navigated between, and so on. In one or more implementations, this is different than functionality employed by a task manager to “kill” (e.g., stop execution) of an application, which does not involve sending events to the application 110. The result of closing an app through the typical “application lifecycle” is that the application 110 is able to save user data and exit gracefully.

FIG. 2 illustrates a system 200 in an example implementation of the application manager module 114 of FIG. 1 as supporting display instance management techniques. The computing device 102 includes an operating system 108, application 110, and application manager module 114 as before. In this instance, a single application 110 is shown that includes a plurality of display instances 202, 204.

As previously described, the application manager module 114 may be configured to support an immersive environment such as those found on a mobile phone or tablet operating system although other examples are also contemplated, such as desktop computer. Applications executed in such an environment are conventionally limited to a single instance.

As before, the application manager module 114 may be configured to employ techniques to manage the application 110, such as to control access to display instances 202, 204, e.g., which display instance 202, 204 can appear on the screen at any given time. Display instances 202, 204 may be thought of as viewports via which content specified by the applications 110 is displayed by the application manager module 114.

The application manager module 114, for instance, may be configured to manage “how” the content is displayed, such as primacy, sizing, arrangement, and so on. Thus, this functionality is not performed in this example by the application 110 as in conventional techniques but rather by an application manager module 114 that is configured to manage the immersive environment. Further, through use of the application manager module 114, multitasking functionality may be leveraged to navigate through the display instances 202, 204 of a single application 110 in a manner that mimics navigation between display instances of a plurality of applications.

For example, the display instances 202, 204 are each illustrated as corresponding to a respective process 206, 208, which may have one or more threads. In one or more implementations, the application manager module 114 may manage groups the display instances 202, 204 for display, one at a time, for the application 110 by default.

The application 110, however, may also leverage one or more application programming interfaces 210 (APIs) to specify (i.e., switch) which of the display instances 202, 204 are to be displayed at any given time. This switch can be performed using an animated transition provided by the application manager module 114, specified by the application 110 itself through the APIs 210, and so forth.

Further, the application manager module 114 may support techniques to manage security and reliability. For example, process 206 of the application 110 may have “full trust” permissions that are usable to lists the user's private documents in a display instance 202. Process 208 of display instance 204, however, may be given “low trust” permissions to display content, e.g., an individual document.

Should that individual document of display instance 204 become corrupted (e.g., by malicious or faulty code), process isolation supported by the application manager module 114 may be used to prevent code running that process 208 from crashing the process 206 listing the documents, may prevent alterations to or access to the user's private documents in display instance 202 of process 206, and so on. Further, this process model may be entirely opaque to the end-user, i.e., the application 110 may still look and feel like a single instance of an immersive application to a user.

Further, the application manager module 114 may employ techniques that are usable to provide a consistent user experience. For example, the APIs 210 used for switching may take into account situations that may be out of the control of a developer of the application 110, such as the application's framework pausing drawing or the system swapping the application out to disk. In such instances, the API 210 of the application manager module 114 may be used to ensure that a switch does not occur until the incoming display instance from the application 110 is ready to be displayed, e.g., sufficient content, whether the content has been corrupted, and so forth.

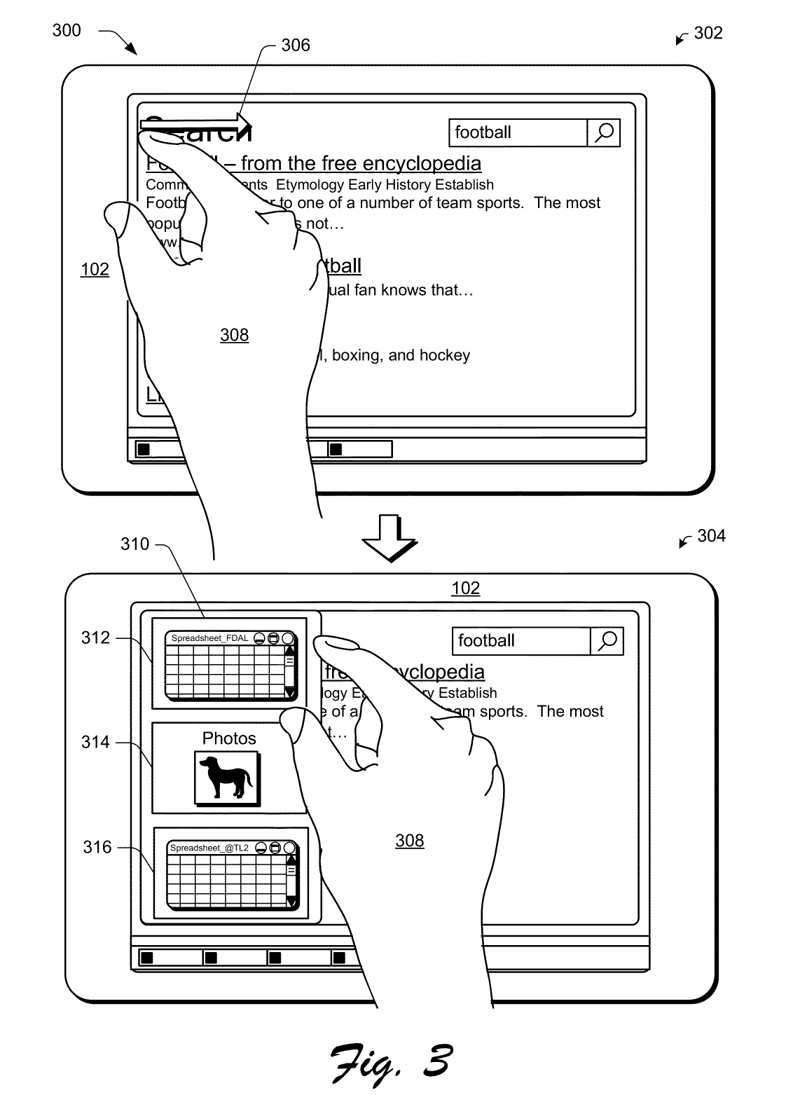

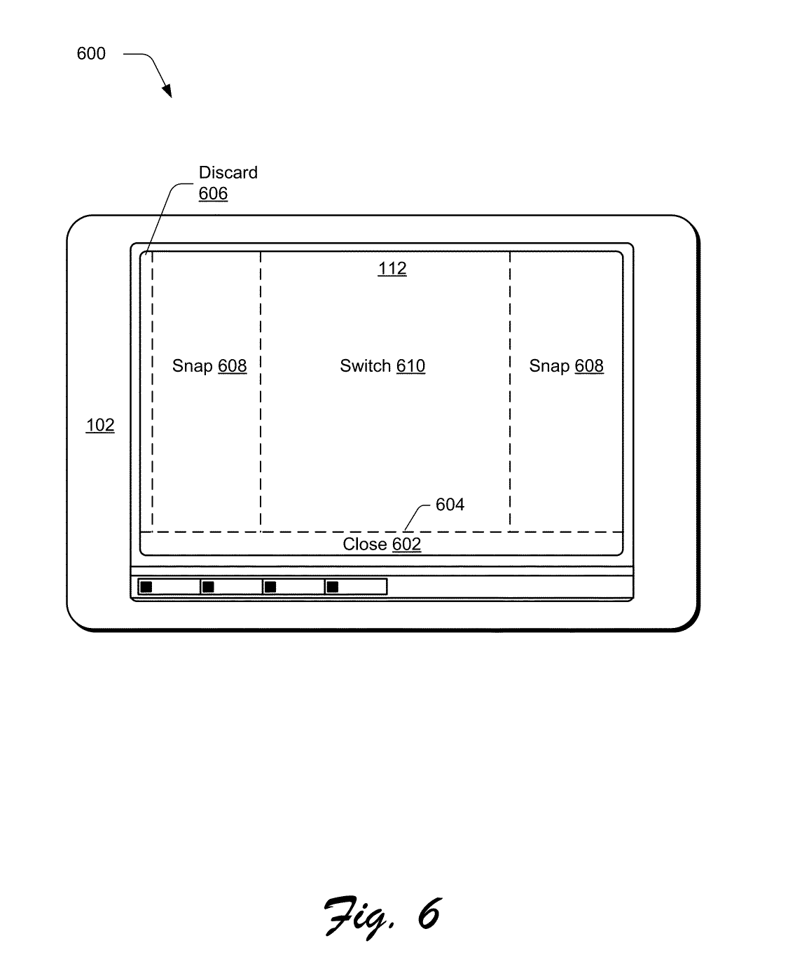

The application 110 may also use one or more of the APIs 210 to promote a display instance 202 to be represented as a separate application inside the application manager module's 114 multitasking model. For example, the promoted display instance 202 may appear as a standalone entry in the system's list of running applications as shown in FIG. 3, can be positioned on the screen the same way any normal single-instance immersive application as shown in FIG. 6, and so on. Further, this technique may be performed without requiring use of separate processes. Thus, in this example the application manager module 114 may support several separate display instances 202, 204 of the application 110 without forcing a developer of the application 110 to deal with the complexity of supporting several processes.

The application manager module 114 may also enforce policy around the creation of these standalone entries to ensure a consistent user experience. For example, if the application 110 is not visible, the application 110 may be prevented by the application manager module 114 from creating a separate instance. This may be used to prevent the multitasking model of the application manager module 114 from being overwhelmed by an overabundance of separate instances.

Further, the switching functionality of the APIs 210 described above may continue to function identically to the application 110, even if the two display instances 202, 204 involved in the switch have been promoted into separate applications for purposes of representation in the user interface. In this way, the application 110 may be configured without functionality to track if display instances have ever been separated, but can use this information to alter the experience around switching For example, the application 110 may be written to select a different animation if the two display instances 202, 204 of the single application 110 have been promoted into representation as separate applications for multitasking and management purposes by the application manager module 114.

As also described, the lifetime of separate display instances 202, 204 of the application 110 are managed by the application manager module 114. The application manager module 114, for instance, may automatically remove display instances 202, 204 that are not used within a threshold amount of time. A user, for instance, may interact with display instance 202 but not display instance 204 within a threshold amount of time. In response, the application manager module 114 may close display instance 204, thereby merging the application 110 into a single display instance 202.

The application manager module 114 may then inform the application 110 as to any changes in the representation of each display instance 202, 204. In one or more implementations, even if a display instance is removed from a running applications list maintained by the application manager module 114, the application manager module 114 does not automatically destroy data structures associated with the display instance 204, which could be unexpected by the application 110 and therefore cause errors.

Each display instance 202, 204 of the application 110 may host different content specified by the application 110 and managed by the application manager module 114. Further, the application manager module 114 may accommodate different kinds of relationships among the display instances 202, 204 having the different content. In one example, a first display instance 202 shown by the application 110 has access to all of the functionality offered by the application 110. A social network application, for instance, may put a list of contacts, a list of the current chats, options to start a new chat, and so in inside this first display instance 202. The application 110 may also offer the ability for the user to take a particular part of the experience and place it inside another display instance 204, which may be promoted to be a standalone instance of the application 110. The social network application, for example, may allow the user to turn a single conversation started in a first display instance 202 into another separate display instance 204. Additionally, the second display instance 204 may support switching through the application manager module 114 back to the first display instance 202 of the application 110.

The application 110 may also use each of its display instances 202, 204 to display a complete, separate instance of execution of the application 110, which may be referred to as execution instances of the application 110. For instance, the application 110 may have separate instances of code execution and therefore may be referred to as execution instances.

A file manager, for example, might allow each display instance 202, 204 to have a corresponding execution instance that is identical in terms of functionality and disconnected from every other display and execution instance. In cases where the application manager module 114 does choose one of the execution instances to complete some operation (for example, opening up a file provided by another application), the application 110 may be configured to designate which of its execution instances and corresponding display instances 202, 204 are to be used to complete the operation. In another example, the application 110 may be configured such that the application manager module 114 decides which instance is to be used to complete the operation. Other examples are also contemplated, including examples of navigation between display instances and management of display instances that mimics that of applications which are further described below.

FIG. 3 depicts an example implementation of a system 300 showing management of applications and display instances of applications by the application manager module 114. This system 300 is shown through use of first and second stages 302, 304. As previously described, the operating system 108 may maintain an immersive environment in which a display of one or more applications may substantially consume a display environment of one or more display devices. However, applications may also “remain available” by the operating system 108 through use of a back stack in which execution of the application is suspended until it appears on the display device 112.

A user, for instance, may make a swipe gesture 306 through one or more fingers of the users hand 308, a “click and drag” gesture, and so on to cause output of a list 310 of representations 312, 314, 316 of applications that are currently available via the back stack. In this example, the representations 312-316 include applications that are not currently being executed but are available to return to a state at which execution of the respective applications is suspended.

Further, representations 312, 316 correspond to separate display instances 202, 204 of an application 110, which is configured as a spreadsheet application in this example. For example, these display instances 202, 204 may correspond to different spreadsheets that are to be made accessible to a user. In this way, the different display instances 202, 204 may leverage multitasking and switching functionality of the application manager module 114 to navigate between the display instances 202, 204 in a manner that mimics navigation between applications.

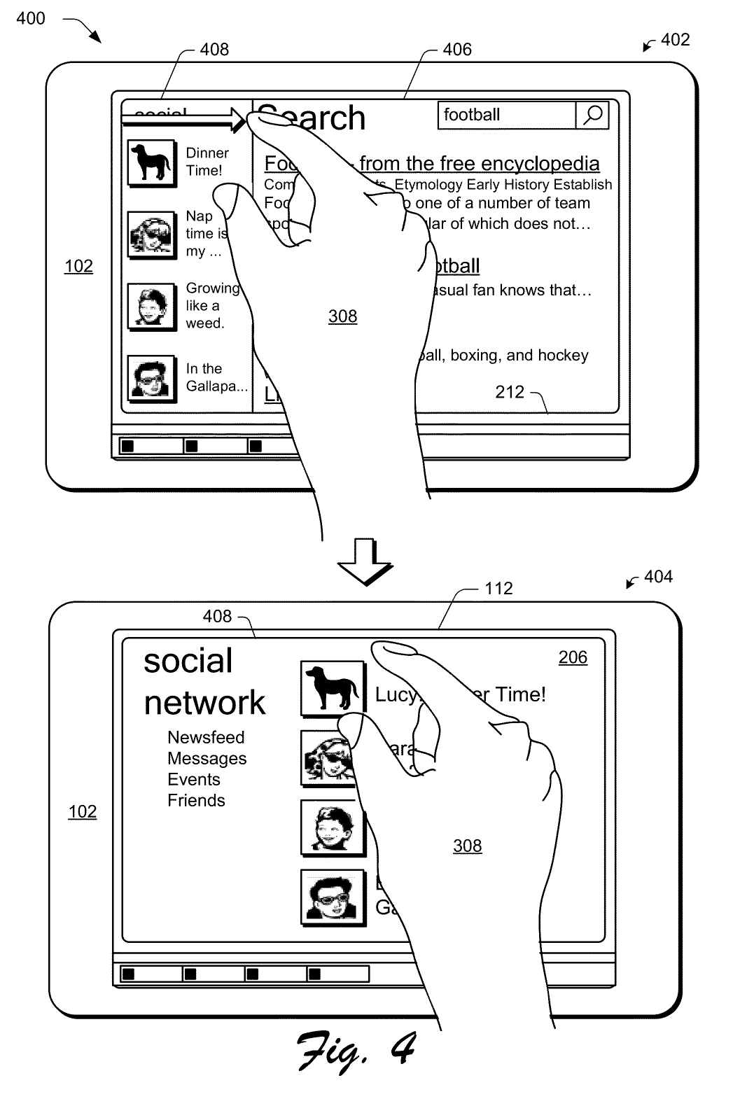

FIG. 4 depicts a system 400 in an example implementation in which navigation between display instances of a single application using an edge gesture is shown. This system 400 is illustrated through use of first and second stages 402, 404. At the first stage 402, a user interface displayed by the display device 112 includes a display instance 406 of a browser application, which in this instance is a webpage of a search engine.

An edge gesture is also illustrated that is detected that involves a swipe detected as starting proximal to a bezel of the computing device 102 and subsequent movement away from the bezel. Responsive to the gesture, another display instance 408 of the browser application is displayed as following the finger of the user's hand 308, which in this case includes content from a webpage of a social network website. The other display instance 408 is then shown at the second stage 404 as replacing the previously display instance 406. In this way, a user may navigate through display instances of a single application as well as other applications that are in a back stack through successive gestures in a manner similar to navigating through a carousel.

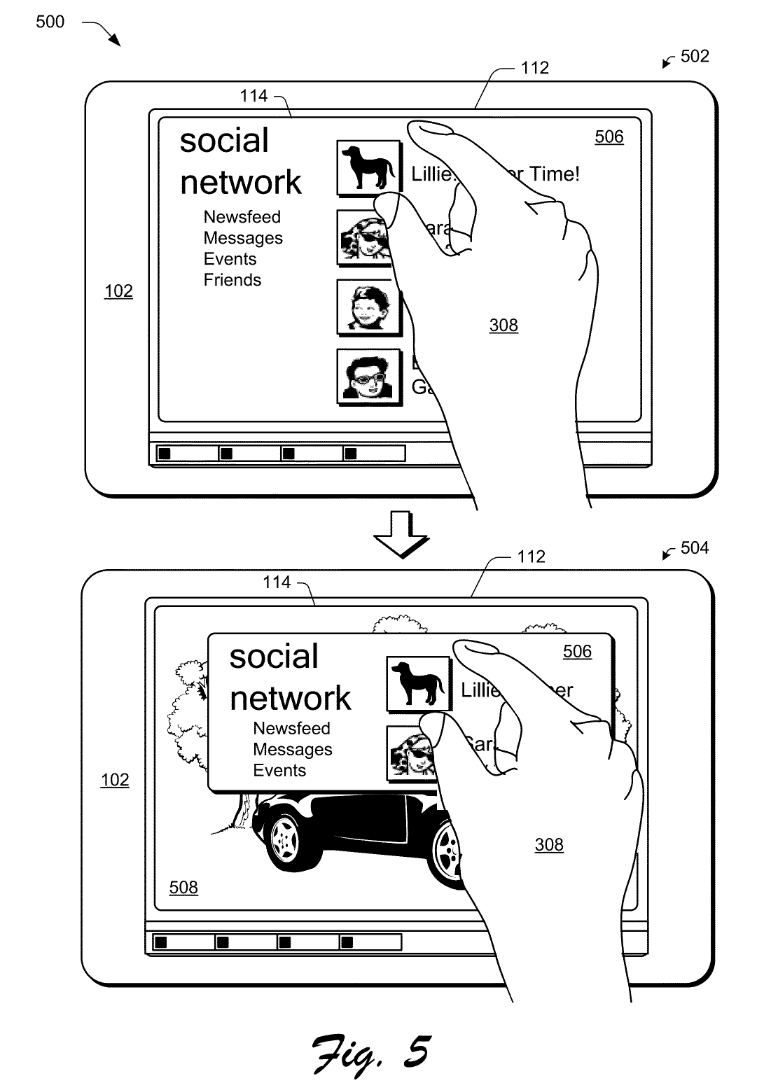

FIG. 5 depicts a system 500 in an example implementation in which selection and configuration of a display instance in a manner that mimics selection and docking of an application is shown. The system 500 is illustrated as including first and second stages 502, 504. At the first stage 502, the computing device 102 is illustrated as outputting a user interface having a display instance 506 of a social network application in an immersive environment and displaying the user interface on a display device 114, although other environments are contemplated as previously described. Further, it should be noted that although a display environment implemented using a single display device is shown, it should be readily apparent that a display environment may leverage a plurality of display devices without departing from the spirit and scope thereof.

A finger of the user's hand 308 is illustrated in the first stage 502 as selecting a portion of a display instance of the application that is near a top edge of a display environment. The selection may be detected using touchscreen functionality of the display device 112, such as to contact the display device 112. A variety of other examples are also contemplated, such as through positioning of a cursor through use of a cursor control device near the top edge and then performing a “click and hold” in which a button of the cursor control device is “held down.”

As shown in the second stage 504 of FIG. 5, the point at which the display instance 506 of the application was selected is then moved away from the top edge and toward a bottom edge. In response to this movement the display instance 506 of the application is configured to follow this subsequent movement of the selection of the application. Further, display characteristics may be changed to indicate the selection, such as lessening an amount of display area of the display environment consumed by the display instance 506 of the application, thereby exposing another display instance 508 of an application, which may be the same as or different from the application corresponding to the display instance 506. Other characteristics are also contemplated, such as changing a transparency of the display, color, and so forth. Thus, these characteristics may be used to give feedback to the user regarding selection of the display instance 506. This selection may then be used as a basis to manage how and if the display instance 506 of the application is displayed, as further described in relation to the following figure.

FIG. 6 is an illustration of a system 600 in an example implementation showing areas of a display environment defined by thresholds to perform different actions after selection of display instances of an application. A close 602 region is shown as defined between a threshold 604 and a bottom edge of the display environment. In this example, the threshold 604 may be defined statically, e.g., at a defined distance from the bottom edge, such as for a gesture recognized using touch functionality of the display device 112. Other examples are also contemplated, such as a dynamic threshold defined as a percentage of movement between edges (e.g., the top and bottom edges), such as twenty five percent for movement input using a cursor control device.

Thus, the close 602 region may be used to define “when” the close operation is available for a display instance of an application that is “moved within” the region. This may include changing display characteristics to indicate availability as described in relation to FIG. 5.

Use of regions may also be used to allow a user to exit this mode, such as in an instance in which a user reconsiders, inadvertently entered the mode the close the application, and so on. For example, once moving into the close 602 region and upon receiving feedback that the close operation is available through the change in display characteristics, the user may reconsider. Accordingly, the user may then move a point of contact (e.g., a finger of the user's hand 308) back outside of the close 602 region. Accordingly, the application manager module 114 may return the display instance of the application to the selection state as shown in FIG. 5.

Other regions may also be defined for implementation as part of the display environment. For example, a discard 606 region may be defined along another edge of the display environment, e.g., the left edge in the illustrated example. Movement of the display instance of the application in the selected state to the discard 606 region may cause the application manager module 114 to exit the selection mode, e.g., to return to a state in the display environment as was achieved before the selection in FIG. 5.

In another example, snap 608 regions may be defined to “dock” a display instance of an application along an edge of the display environment. As described and shown in relation to FIG. 1, for instance, an immersive environment may support a concurrent display of display instances from a single or plurality of applications that is separated by a separator 120 that is configured to adjust an amount of display area of the display device 112 that is consumed by the respective applications. In a further example, a switch region may be defined, such as to move an application from a snap 608 region in a selected state to the switch 610 region. A variety of other examples are also contemplated. In this way, a user may interact with display instances in a manner that mimics interaction between applications that is supported by the application manager module 114 as previously described. Further examples are described in relation to the following section.

Example Procedures

The following discussion describes display instance management techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and systems 200-600 of FIGS. 2-6, respectively.

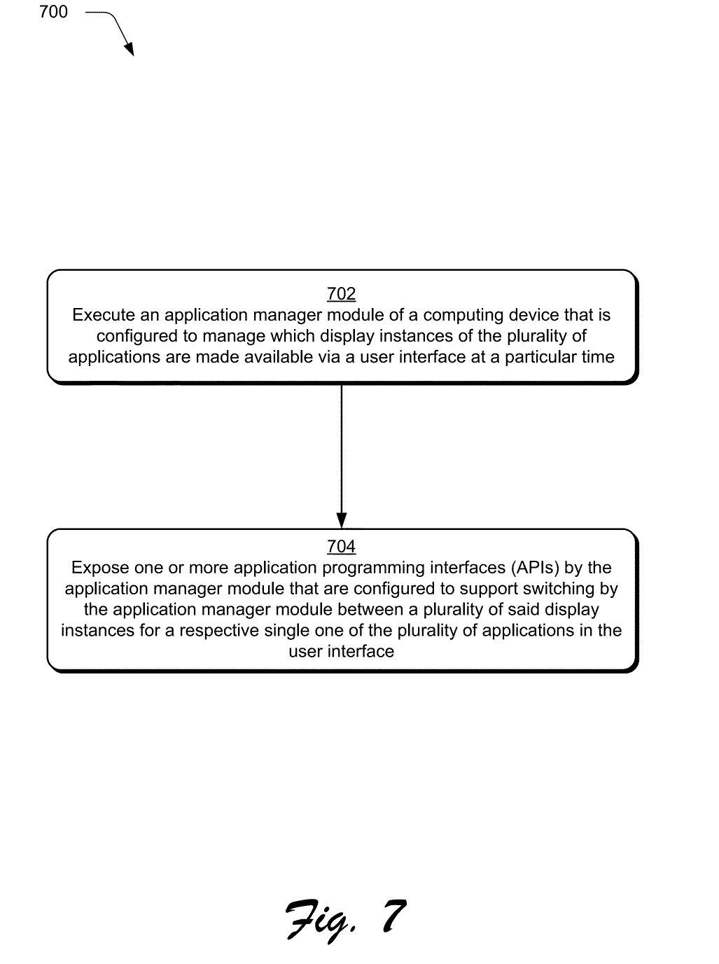

FIG. 7 depicts a procedure 700 in an example implementation in which an application manager module 114 is executed to manage a plurality of display instances for a single application. An application manager module of a computing device is executed that is configured to manage which display instances of the plurality of applications are made available via a user interface at a particular time (block 702). The application manager module 114, for instance, may be configured to use multitasking and navigation functionality for use to control access to individual display instances. This may include docking of the display instances, use of gestures to navigate display instances, and so on in an immersive environment. In this way, this management may be performed “outside” of the applications, themselves.

One or more application programming interfaces (APIs) are exposed by the application manager module that are configured to support switching by the application manager module between a plurality of the display instances for a respective single one of the plurality of applications in the user interface (block 704). Application 110, for instance, may interact with the application manager module 114 via one or more APIs 210 to control switching between display instances 202, 204. In this way, the application manager module 114 may manage the “how” content specified by the application 210 is to be displayed. A variety of other examples are also contemplated as previously described.

Example System and Device

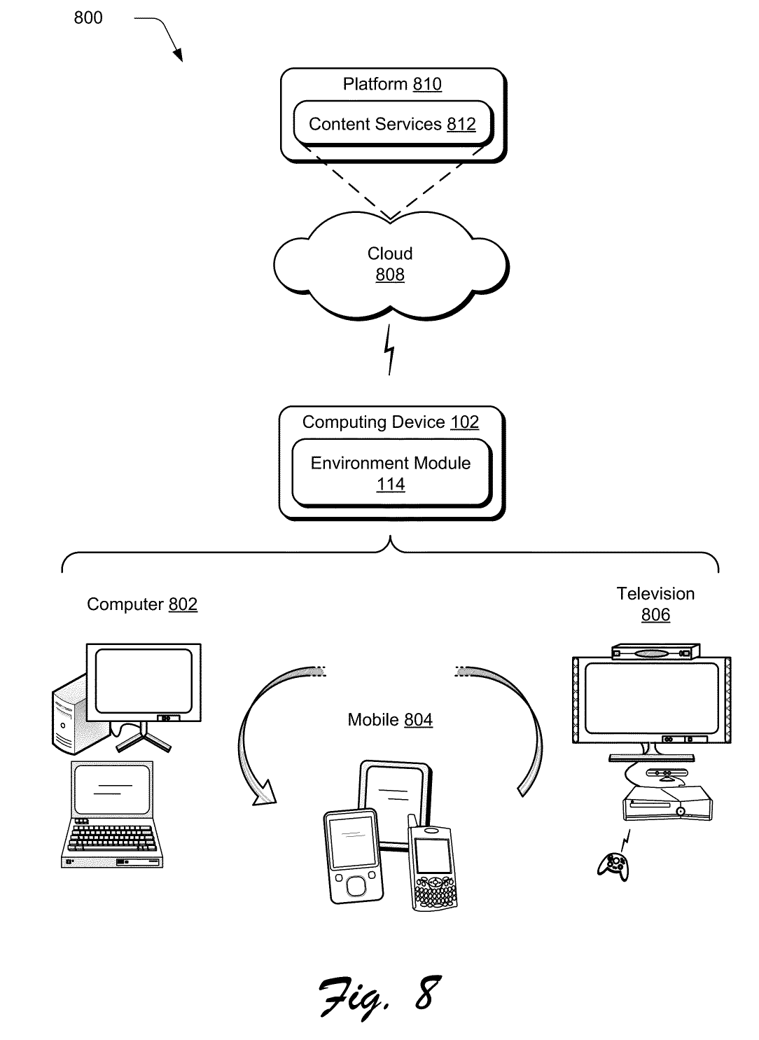

FIG. 8 illustrates an example system 800 that includes the computing device 102 as described with reference to FIG. 1. The example system 800 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 802, mobile 804, and television 806 uses. Each of these configurations includes devices that may have generally different constructs and capabilities, and thus the computing device 102 may be configured according to one or more of the different device classes. For instance, the computing device 102 may be implemented as the computer 802 class of a device that includes a personal computer, desktop computer, a multi-screen computer, laptop computer, netbook, and so on.

The computing device 102 may also be implemented as the mobile 804 class of device that includes mobile devices, such as a mobile phone, portable music player, portable gaming device, a tablet computer, a multi-screen computer, and so on. The computing device 102 may also be implemented as the television 806 class of device that includes devices having or connected to generally larger screens in casual viewing environments. These devices include televisions, set-top boxes, gaming consoles, and so on. The techniques described herein may be supported by these various configurations of the computing device 102 and are not limited to the specific examples the techniques described herein.

The cloud 808 includes and/or is representative of a platform 810 for content services 812. The platform 810 abstracts underlying functionality of hardware (e.g., servers) and software resources of the cloud 808. The content services 812 may include applications and/or data that can be utilized while computer processing is executed on servers that are remote from the computing device 102. Content services 812 can be provided as a service over the Internet and/or through a subscriber network, such as a cellular or Wi-Fi network.

The platform 810 may abstract resources and functions to connect the computing device 102 with other computing devices. The platform 810 may also serve to abstract scaling of resources to provide a corresponding level of scale to encountered demand for the content services 812 that are implemented via the platform 810. Accordingly, in an interconnected device embodiment, implementation of functionality of the functionality described herein may be distributed throughout the system 800. For example, the functionality may be implemented in part on the computing device 102 as well as via the platform 810 that abstracts the functionality of the cloud 808.

FIG. 9 illustrates various components of an example device 900 that can be implemented as any type of computing device as described with reference to FIGS. 1-8 to implement embodiments of the techniques described herein. Device 900 includes communication devices 902 that enable wired and/or wireless communication of device data 904 (e.g., received data, data that is being received, data scheduled for broadcast, data packets of the data, etc.). The device data 904 or other device content can include configuration settings of the device, media content stored on the device, and/or information associated with a user of the device. Media content stored on device 900 can include any type of audio, video, and/or image data. Device 900 includes one or more data inputs 906 via which any type of data, media content, and/or inputs can be received, such as user-selectable inputs, messages, music, television media content, recorded video content, and any other type of audio, video, and/or image data received from any content and/or data source.

Device 900 also includes communication interfaces 908 that can be implemented as any one or more of a serial and/or parallel interface, a wireless interface, any type of network interface, a modem, and as any other type of communication interface. The communication interfaces 908 provide a connection and/or communication links between device 900 and a communication network by which other electronic, computing, and communication devices communicate data with device 900.

Device 900 includes one or more processors 910 (e.g., any of microprocessors, controllers, and the like) which process various computer-executable instructions to control the operation of device 900 and to implement embodiments of the techniques described herein. Alternatively or in addition, device 900 can be implemented with any one or combination of hardware, firmware, or fixed logic circuitry that is implemented in connection with processing and control circuits which are generally identified at 912. Although not shown, device 900 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 900 also includes computer-readable media 914, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 900 can also include a mass storage media device 916.

Computer-readable media 914 provides data storage mechanisms to store the device data 904, as well as various device applications 918 and any other types of information and/or data related to operational aspects of device 900. For example, an operating system 920 can be maintained as a computer application with the computer-readable media 914 and executed on processors 910. The device applications 918 can include a device manager (e.g., a control application, software application, signal processing and control module, code that is native to a particular device, a hardware abstraction layer for a particular device, etc.). The device applications 918 also include any system components or modules to implement embodiments of the techniques described herein. In this example, the device applications 918 include an interface application 922 and an input/output module 924 that are shown as software modules and/or computer applications. The input/output module 924 is representative of software that is used to provide an interface with a device configured to capture inputs, such as a touchscreen, track pad, camera, microphone, and so on. Alternatively or in addition, the interface application 922 and the input/output module 924 can be implemented as hardware, software, firmware, or any combination thereof. Additionally, the input/output module 924 may be configured to support multiple input devices, such as separate devices to capture visual and audio inputs, respectively.

Device 900 also includes an audio and/or video input-output system 926 that provides audio data to an audio system 928 and/or provides video data to a display system 930. The audio system 928 and/or the display system 930 can include any devices that process, display, and/or otherwise render audio, video, and image data. Video signals and audio signals can be communicated from device 900 to an audio device and/or to a display device via an RF (radio frequency) link, S-video link, composite video link, component video link, DVI (digital video interface), analog audio connection, or other similar communication link. In an embodiment, the audio system 928 and/or the display system 930 are implemented as external components to device 900. Alternatively, the audio system 928 and/or the display system 930 are implemented as integrated components of example device 900.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
executing an application manager module of a computing device that is configured to manage which display instances of the plurality of applications are made available via a user interface at a particular time; and
exposing one or more application programming interfaces (APIs) by the application manager module that are configured to support switching by the application manager module between a plurality of said display instances for a respective single one of the plurality of applications in the user interface.

2. A method as described in claim 1, wherein the application manager module is configured as part of an operating system of the computing device and is configured to support an immersive environment in which the display instances of the plurality of applications are to be displayed concurrently.

3. A method as described in claim 2, wherein the application manager module is configured support the immersive environment by managing a lifetime of the display instances or managing which of the plurality of applications are currently executed based on which of the display instances are currently made available via the user interface.

4. A method as described in claim 1, wherein each of the plurality of said display instances for the respective single application corresponds to separate one of a plurality of processes for the single application.

5. A method as described in claim 1, wherein the display instances are configured as viewports for which a corresponding said application specifies content for viewing in the user interface, the viewports curated by the application manager module such that the corresponding said application is not aware as to how the specified content is displayed.

6. A method as described in claim 1, wherein at least one of the exposed APIs is configured to promote the plurality of said display instances as standalone entries for the single application.

7. A method as described in claim 1, wherein at least one of the exposed APIs is configured to specify an animation to be used to switch between the plurality of said display instances for the single application.

8. A method as described in claim 1, wherein the application manager module is configured to support switching between the plurality of display instances through use of a gesture.

9. A method as described in claim 8, wherein the gesture is an edge gesture.

10. A system comprising one or more modules implemented at least partially in hardware, the one or more modules configured to curate content specified by respective ones of a plurality of applications for display in a plurality of display instances in a user interface such that respective said applications specify the content but are not aware as to how that content is displayed, the content of at least two said display instances specified by a single said application.

11. A system as described in claim 10, wherein the plurality of display instances correspond to separate viewports in an immersive environment.

12. A system as described in claim 11, wherein the one or more modules are configured to support the immersive environment by managing a lifetime of the display instances or managing which of the plurality of applications are currently executed based on which of the display instances are currently made available via the user interface.

13. A system as described in claim 10, wherein the one or more modules are configured to support switching between at least two said display instances specified by a single said application in the user interface using techniques that match those that are available to switch between the display instances of different said applications.

14. A system as described in claim 10, wherein the one or more modules are configured to expose one or more application programming interfaces (APIs) configured to promote the at least two said display instances specified by the single said application as standalone entries.

15. A system as described in claim 10, wherein the one or more modules are configured to expose one or more application programming interfaces (APIs) configured to specify an animation to be used to switch between the plurality of said display instances for the single application.

16. One or more computer-readable storage media comprising instructions stored thereon that, responsive to execution by a computing device, causes the computing device to execute an application manager module that is configured to perform operations comprising:
exposing one or more application programming interfaces (APIs) that are configured to support switching between a plurality of display instances for a respective ones of a plurality of applications in a user interface;
managing lifetimes of the plurality of display instances of the plurality of applications; and
curating content specified by respective ones of a plurality of applications for display in the plurality of display instances.

17. One or more computer-readable storage media as described in claim 16, wherein at least two said display instances correspond to a single said application.

18. One or more computer-readable storage media as described in claim 16, wherein curating is performed such that respective said applications specify the content but are not aware as to how that content is displayed

19. One or more computer-readable storage media as described in claim 16, wherein the application manager module is configured to expose one or more application programming interfaces (APIs) configured to promote the at least two said display instances specified by the single said application as standalone entries.

20. One or more computer-readable storage media as described in claim 16, wherein the application manager module is configured to expose one or more application programming interfaces (APIs) configured to specify an animation to be used to switch between the plurality of said display instances for the single application.
